(19) United States
(12) Patent Application Publication
(10) Pub. No.: US 2026/0250209 A1
(43) Pub. Date: Aug. 27, 2026

(54) MATERIAL PREPARATION SYSTEMS AND RELATED DEVICES AND METHODS OF PREPARING CEMENTITIOUS MATERIALS

(71) Applicant: Saudi Arabian Oil Company, Dhahran (SA)

(72) Inventors: Waleed K. Al Shammari, Al Khobar (SA); Mohammed Al Mehthel, Dhahran (SA); Sami A. Al Abduljabbar, Dhahran (SA); Nawaf Abdulrahman Alubaidi, Dhahran (SA)

(21) Appl. No.: 19/061,129

(22) Filed: Feb. 24, 2025

(51) Int. Cl. C04B 40/02; B01F 23/231; C04B 40/00

(52) U.S. Cl. CPC C04B 40/0091; C04B 40/0067; B01F 23/23123; B01F 23/231263

(57) ABSTRACT

A material preparation system includes a receptacle configured to contain a cementitious material, a vibrator configured to be disposed within the cementitious material while the cementitious material is disposed within the receptacle and in a fresh state, and an injection nozzle. The injection nozzle includes a main body, a perforated plate coupled to the main body, and a mesh structure coupled to a bottom end region of the main body and configured to prevent solid particles within the cementitious material from entering the main body.

### TECHNICAL FIELD

This disclosure relates to material preparation systems, such as those that are designed to vibrate or otherwise disturb a fresh cementitious material before or during consolidation while CO₂ gas is introduced to the cementitious material.

### BACKGROUND

For cementitiouse materials applications (e.g., building and construction applications), mixing and curing cementitious materials using carbon dioxide (CO₂) has several limitations. For example, introducing CO₂ during mixing of cementitious materials has very limited CO₂ uptake, such as in a range of 0.1 to 0.2% by mass of cement. For this reason, when the uptake is higher than 0.2% by mass of cement, CO₂ introduction will negatively impact the workability of the cementitious material mixture. Furthermore, curing of cementitious materials with CO₂ is limited to the application of precast concrete members.

### SUMMARY

This disclosure relates to introducing CO₂ in a cementitious material while the material is in a freshly poured state and during the process of consolidating the material or prior to commencing consolidation of the material. The manner of consolidation includes vibration-based mechanisms and non-vibration-based mechanisms. Advantageously, the introduction can be applied to both cast in-situ and precast concrete members. Such introduction also allows CO₂ to react with the cementitious material at all levels within a receptacle, and not just at the surface. Additionally, CO₂-carbonated products will displace air entrained in the matrix. Moreover, such advantages can be achieved using the devices and systems described herein in several applications. These applications include all types of concrete and cement-based products and applications, precast and cast in place concrete members, backfill where controlled low-strength material (CLSM) is used as backfill in place of compacted soil, structural fill, insulating and isolation fill, thermal insulation, sound insulation, pavement bases utilities conduits bedding, concrete duct banks, cavities fill, lining drainage and other civil applications, roof filling, screeds, pavement, floors, and wall panels.

In some embodiments, the technique may be implemented with a vibrator and a CO₂ injection nozzle. An example nozzle includes one or more mesh structures that prevent solids in the fresh cementitious material from entering the nozzle or from passing through and out of the nozzle. An example nozzle includes a conical (e.g., frustoconical) mesh structure through which the CO₂ passes out of the nozzle in all directions around a circumference of the nozzle. Other example nozzles are also disclosed.

The details of one or more embodiments are set forth in the accompanying drawings and description. Other features, aspects, and advantages of the embodiments will become apparent from the description, drawings, and claims.

### DESCRIPTION OF DRAWINGS

FIG. 1 is a side view of an example material preparation system that is operational to prepare one or more cementitious materials.

FIG. 2A is a side cutaway view of an example injection nozzle of the material preparation system of FIG. 1.

FIG. 2B is a cross-sectional view of the injection nozzle of FIG. 2A from above a perforated plate of the injection nozzle.

FIG. 3 is a side cutaway view of the injection nozzle of FIG. 2A, equipped with a secondary mesh structure.

FIG. 4A is a side cross-sectional view of an example injection nozzle of the cement preparation system of FIG. 1.

FIG. 4B is a front cross-sectional view of the injection nozzle of FIG. 4A.

FIG. 4C is a top view of a perforated plate of the injection nozzle of FIG. 4A.

FIG. 5A is a side cross-sectional view of an example injection nozzle of the material preparation system of FIG. 1.

FIG. 5B is a top view of a perforated plate of the injection nozzle of FIG. 5A.

FIG. 6A is a side cross-sectional view of an example injection nozzle of the material preparation system of FIG. 1.

FIG. 6B is a top view of a perforated plate of the material preparation system of FIG. 1.

FIG. 7 is a flow chart illustrating an example method of preparing a cementitious material.

### DETAILED DESCRIPTION

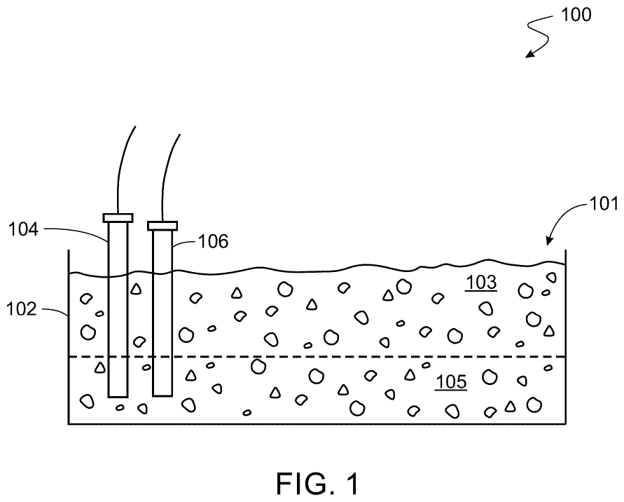

FIG. 1 illustrates an example material preparation system 100 for preparing one or more cementitious materials 101. For example, the material preparation system 100 may be operated to carry out CO₂ mineralization of cementitious materials 101 before or during a consolidation process. The system 100 includes a receptacle 102 containing the cementitious materials 101, a vibrator 104 disposed within the cementitious materials 101, and an injection nozzle 106 disposed within the cementitious materials 101. The cementitious materials 101 includes two freshly poured layers 103, 105 of cementitious materials that are in a fresh state and in the process of being consolidated, where consolidation is a process separate from mixing and from curing. In some examples, a fresh state refers to a plastic state or a state, otherwise, in which the cementitious materials 101 can be poured and shaped at a final place (e.g., a mold or pavin) of the cementitious materials 101. In some examples, a cementitious material 101 is any material that includes cement as one of its components, such as concrete, mortar, or paste. The vibrator 104 and the injection nozzle 106 are positioned so as to penetrate and span both the upper and lower cementitious layers 103, 105. The vibrator 104 vibrates or otherwise disturbs the cementitious materials 101 to facilitate the consolidation process. In some examples, the nozzle 106 may be utilized before or during the consolidation process along with a technique or device other than the vibrator 104, such as screed-based consolidation techniques, table-based consolidation, roller-based consolidation, ramming, external consolidation, or other devices or techniques.

In some examples, the cementitious materials 101 include a cement in accordance with the standards of American Society for Testing and Materials (ASTM) C150, ASTM C595, ASTM C1709, ASTM C1157. In some examples, the cement is a cement in accordance with other standards. In some examples, the cementitious materials 101 include a composition that includes one or more of sand, coarse aggregates, water, lime, cement, foam agents, and air-entrained admixtures and other admixtures that are used to achieve specific properties of concrete and other cement-based materials. In some examples, the cementitious materials 101 include a composition that includes natural materials and/or industrial by-products that are used as a filler or as partial replacement of cement. The compositions include natural materials, industrial by-products, and recycled materials (e.g., recycled plastic, steel dust, volcanic ash, silica fume, blast furnace slag, fly ash, oil ash, red muds, bag house dust, slag, gypsum or kiln dust, calcium carbide slag, steel industry by-products, concrete industry by-products, and construction demolition wastes). In some examples, the cementitious materials 101 includes any type of concrete or any type of cement-based material.

Components of the cementitious materials 101 may be provided in certain proportions. In some examples, the cementitious materials 101 have certain mix proportions, such as cement at about 50 kilogram (kg) to about 1,000 kg per cubic meter of the cementitious product, sand at about 300 kg to about 2,000 kg per cubic meter of the cementitious product, coarse aggregates at about 0 kg to 1,200 kg per cubic meter of the cementitious product, and a water/cement ratio of about 0.3 to about 0.8. In some examples, the cementitious materials 101 may optionally include one or more supplementary cementitious material at about 0 kg to about 350 kg per cubic meter of cementitious product, fly ash, volcanic ash, silica fume, blast furnace slag, recycled materials (e.g., plastic), steel dust, volcanic ash, fly ash, oil ash, red muds, bag house dust, slag, gypsum, kiln dust, calcium carbide slag, water reducers and retarder admixtures at about 0% to about 2% by mass of cementitious product, air-entrained admixtures at about 0% to about 2% by mass of cementitious product, and foaming agent at about 0.01% to about 1% by mass of mixing water. In some examples, supplemental cementitious materials (e.g., natural pozzolan, fly ash, silica fume, limestone powder, and blast furnace) can be used as partial replacement of cement in a range of about 0% to about 70% by mass of cement product.

In some examples, the injection nozzle 106 is disposed within the cementitious materials 101 to deliver carbon dioxide (CO₂) gas to the cementitious materials 101 either before or during the consolidation stage of the cement preparation process. During the preparation process, the cementitious materials 101 surrounding a head of the vibrator 104 is in a fresh state, and the vibrator 104 causes water and entrapped air to move away from the vibrator 104. Simultaneously, CO₂ that has been injected into the cementitious materials 101 through the injection nozzle 106 reacts with calcium silicate in the presence of the water as follows:

Carbonation of CS₃ and CS₂:

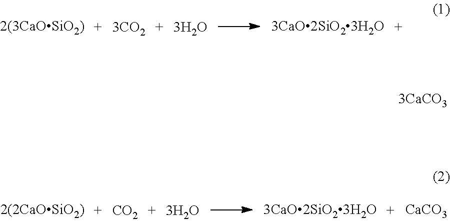

In addition, C₃S and C₂S, when hydrated, will produce C—S—H gel and CH, which will also be carbonated with CO₂:

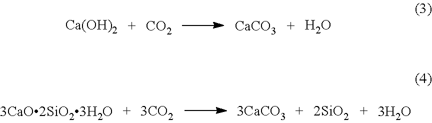

Accordingly, initially, CO₂ reacts with some of the main phases of cement, in the presence of water, to produce carbonate. Next, CO₂ reacts with the hydration products of cement to produce carbonate.

In some examples, introducing CO₂ before or during consolidation of freshly pouring the cementitious materials 101, using the injection nozzle 106 or any of the below-discussed injection nozzles 200, 300, 400, 500, and others, benefits the cementitious material preparation process in several ways as compared to conventional cement preparation processes. For example, such introduction increases CO₂ uptake while some cement hydration products develop. Furthermore, the introduction will not impact workability of the cementitious materials 101 because the cementitious materials 101 will have already been placed. For example, after mixing of the cementitious materials in central mixer or in a truck mixer, the cementitious materials need to be transported to the site and then poured (e.g., placed) in a final structure (e.g., foundation, a wall, etc.). The cementitious materials should be flowable enough (e.g., workable) to be poured. If more than 0.2% CO₂ by mass of cement is introduced during the mixing process, then flowability of the mix will be impacted. Advantageously, the introduction can be applied to both cast in-situ and precast concrete members. Such introduction also allows CO₂ to react with cement hydrated products in the cementitious materials 101 at all levels within the receptacle 102, and not just at the surface. Additionally, CO₂-carbonated products will displace air entrained in the matrix. Additionally, such advantages can be achieved using the devices and systems described herein in several applications. These applications include all types of concrete and cement-based products and applications, precast and cast in place concrete members, backfill where CLSM is used as backfill in place of compacted soil, structural fill, insulating and isolation fill, thermal insulation, sound insulation, pavement, concrete masonry unit, concrete blocks, pavement, flooring, pavement based utilities conduits bedding, concrete duct banks, cavities fill, lining drainage and other civil applications, roof filling, screeds, and wall panels.

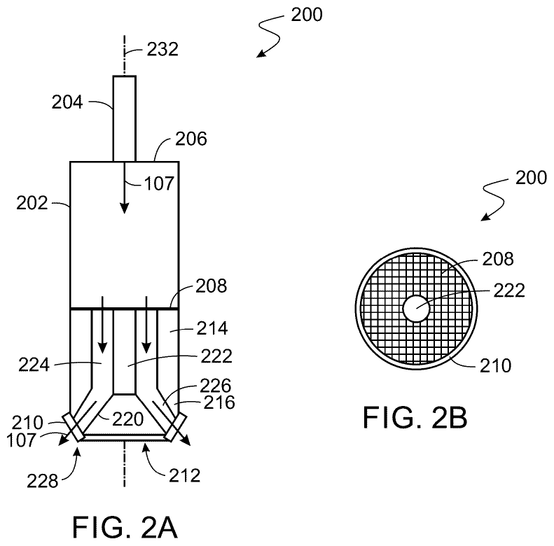

FIGS. 2A and 2B illustrates an example nozzle 200. In some embodiments, the nozzle 200 is an embodiment of the CO₂ injection nozzle 106. The nozzle 200 includes a main body 202, a fluid conduit 204 that is connected to a top end 206 of the main body 202, a perforated plate 208 positioned along a middle region of the main body 202, and a mesh structure 210 (e.g., providing a filtration structure) positioned at a bottom end 212 of the main body 202. The main body 202 has a substantially cylindrical outer profile. The main body 202 includes a cylindrical interior wall 214 that extends downward from the plate 208, a circumferential interior wall 216 extending downward from the wall 214 to a fluid outlet 228 at the bottom end 212, a conical interior wall 220 that extends upward from the bottom end 212, and a cylindrical flow obstruction 222 that extends to the conical wall 220. The wall 216 has a conically shaped inner surface, and the flow obstruction 222 is centered within the wall 214 (e.g., positioned along a central axis 232 of the main body 202) such that a lumen 224 formed by the main body 202 has a conically-shaped fluid outflow path 226 with the fluid outlet 228 (e.g., a circumferential fluid outlet) positioned at the bottom end 212 of the main body 202. The mesh structure 210 is sized, shaped, and positioned to cover the fluid outlet 228 (e.g., surround an exterior surface of the fluid outlet 228). Accordingly, the mesh structure 210 has a conical (e.g., frustoconical) shape.

In operation, CO₂ gas 107 flows from a CO₂ source, through the conduit 204, through the perforated plate 208, through the lumen 224 (e.g., and along the outflow path 226), through the mesh structure 210 and outlet 228, and into the cementitious materials 101 while the cementitious materials 101 are in a liquid phase and experiencing vibration. The plate 208 prevents debris from entering the lumen 224 of the nozzle 200 (e.g., and therefore from passing out of the nozzle 200 into the cementitious materials 101). In some embodiments, the plate 208 has a pore size of about 1 millimeter (mm) to about 10 mm to block such debris. The mesh structure 210 prevents the ingress of any solid particles in the surrounding, liquid cementitious materials 101 from entering and blocking (e.g., plugging) the lumen 224 of the nozzle 200. In some embodiments, the mesh structure 210 has a pore size of about 20 micrometers (μm) to about 150 μm to block such solid particles. In some embodiments, the main body 202 has an outer diameter in a range of about 2 centimeters (cm) to about 10 cm. In some embodiments, the fluid outflow path 226 and the mesh structure 110 have a cross-sectional width of about 5 mm to about 20 mm. In some embodiments, any of the components of the nozzle 200 may be made of one or more of composite materials (e.g., polymers and fibers), stainless steel, carbon steel, copper, or plastic.

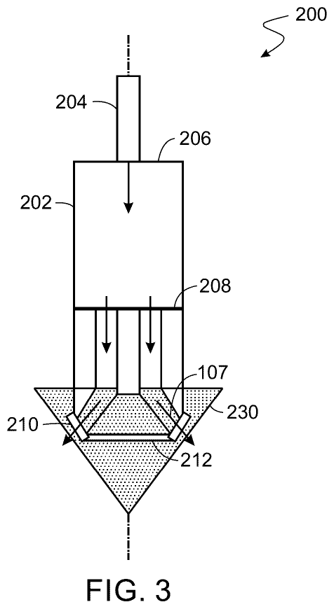

Referring to FIG. 3, in some embodiments, the nozzle 200 may additionally include an additional (e.g., secondary) mesh structure 230 (e.g., providing a filtration structure). The mesh structure 230 has a substantially triangular cross-sectional shape, is coupled to the main body 202 of the nozzle 200, and is positioned to surround a bottom end region of the nozzle 200. The mesh structure 230 prevents solid particles within the cementitious material 101 from reaching the fluid outlet 228 of the nozzle 200 altogether, thereby providing additional prevention of plugging of the nozzle 200. In some embodiments, the mesh structure 230 has a pore size of about 20 μm to about 150 μm to block such solid particles.

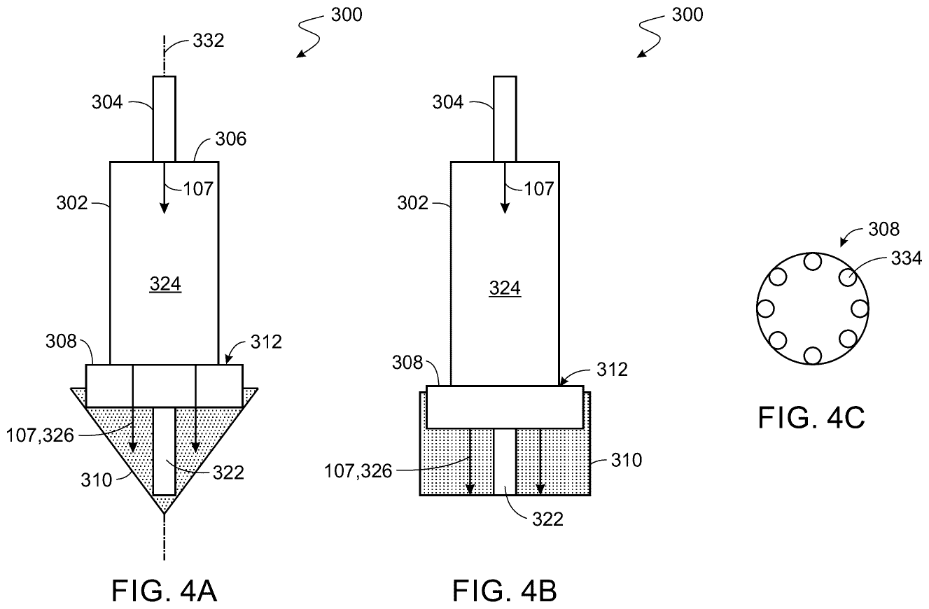

Other embodiments are also possible. For example, FIGS. 4A, 4B, and 4C illustrate another example nozzle 300. In some embodiments, the nozzle 300 is an embodiment of the CO₂ injection nozzle 106. The nozzle 300 includes a main body 302, a fluid conduit 304 that is connected to a top end 306 of the main body 302, a perforated plate 308 positioned at a bottom end 312 of the main body 302, a flow obstruction 322 positioned below the plate 308, and a mesh structure 310 (e.g., providing a filtration structure) positioned at a bottom end 312 of the main body 302. The flow obstruction 322 is positioned along a central axis 332 of the main body 202 such that fluid flowing through the nozzle 300 is prevented from flowing along the central axis 332 and is forced to flow out of the nozzle 300 along a lateral outflow path 326.

In some embodiments, the plate 308 defines multiple openings 334 (e.g., holes) that are approximately equally spaced around a circumference of the plate 308. In some embodiments, the openings 334 serve as fluid outlets of the nozzle 300. The perforated plate 308 also prevents any debris within a lumen 324 of the nozzle 300 from passing through the plate 308 (e.g., and therefore from passing out of the nozzle 300 into the cementitious materials 101), while allowing CO₂ gas 107 to pass through the openings 334 to exit the nozzle 300. In some embodiments, the plate 308 has a pore size of about 1 mm to about 10 mm to block such debris. The mesh structure 310 has a substantially triangular cross-sectional shape, is coupled to the main body 302 of the nozzle 300, and is positioned to surround the bottom end 312 of the nozzle 300. The mesh structure 310 prevents solid particles within the cementitious materials 101 from reaching the openings 334 of the plate 308 altogether, thereby preventing the ingress of such solid particles in the surrounding, liquid cementitious materials 101 from entering and blocking (e.g., plugging) the openings 334 and the lumen 324 of the nozzle 300. In some embodiments, the mesh structure 310 has a pore size of about 20 μm to about 150 μm to block such solid particles.

In operation, CO₂ gas 107 flows from a CO₂ source, through the conduit 304, through the lumen 324, through the perforated plate 308, through the mesh structure 310, and into the cementitious materials 101 while the cementitious materials 101 is in a liquid phase and experiencing vibration. In some embodiments, the main body 302 has an outer diameter in a range of about 2 cm to about 10 cm. In some embodiments, the openings 334 have a diameter in a range of about 1 mm to about 10 mm. Any of the components of the nozzle 300 may be made of one or more of composite materials (e.g., polymers and fibers), stainless steel, carbon steel, copper, and plastic.

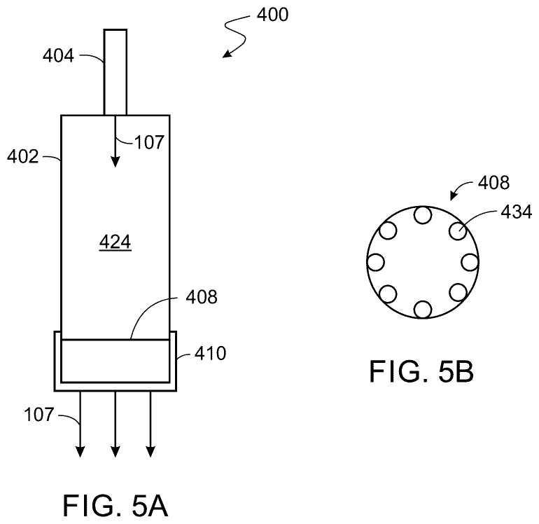

FIGS. 5A and 5B illustrate another example nozzle 400. In some embodiments, the nozzle 400 is an embodiment of the CO₂ injection nozzle 106. The nozzle 400 includes a main body 402, a fluid conduit 404 that is connected to a top end 406 of the main body 402, a perforated plate 408 positioned at a bottom end 412 of the main body 402, and a textile layer 410 (e.g., providing a filtration structure) positioned at the bottom end 412 of the main body 302. In some embodiments, the textile layer 410 is a geotextile layer, such as a synthetic fabric that is a permeable textile or a fabric that permits water to pass through it, while preventing solid particles from passing through it.

In some embodiments, the plate 408 defines multiple openings 434 that are approximately equally spaced around a circumference of the plate 408. In some embodiments, the openings 434 serve as fluid outlets of the nozzle 400. The perforated plate 408 allows CO₂ gas 107 to pass through the openings 434 to exit the nozzle 400. In some embodiments, the plate 408 has a pore size of about 10 mm to about 10 mm to block such debris. The textile layer 410 has a substantially circular cross-sectional shape, is coupled to the main body 402 of the nozzle 400, and is positioned to cover the lower surface of the plate 408. The textile layer 410 prevents solid particles within the cementitious materials 101 from reaching the openings 434 of the plate 408 altogether, thereby preventing the ingress of such solid particles in the surrounding, liquid cementitious materials 101 from entering and blocking (e.g., plugging) the openings 434 and the lumen 424 of the nozzle 400. In some embodiments, the textile layer 410 has a pore size of about 1 μm to about 120 μm to block such solid particles.

In operation, CO₂ gas 107 flows from a CO₂ source, through the conduit 404, through the lumen 424, through the perforated plate 408, through the textile layer 410, and into the cementitious materials 101 while the cementitious materials 101 are in a fresh state and experiencing vibration. In some embodiments, the main body 402 has an outer diameter in a range of about 2 cm to about 10 cm. In some embodiments, the openings 334 have a diameter in a range of about 1 mm to about 10 mm. Any of the components of the nozzle 400 may be made of one or more of composite materials (e.g., polymers and fibers), stainless steel, carbon steel, copper, and plastic.

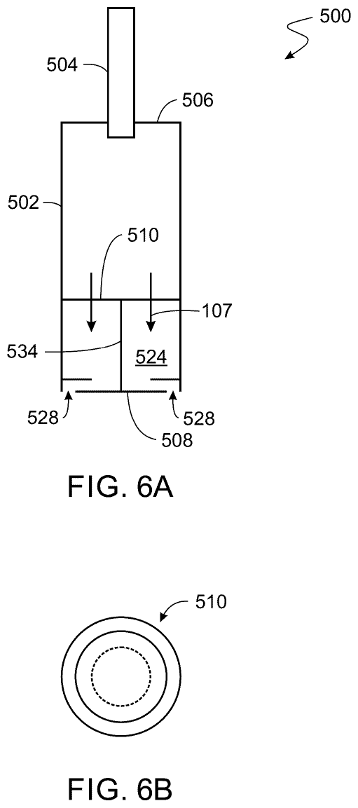

FIG. 6A illustrates another example nozzle 500. In some embodiments, the nozzle 500 is an embodiment of the CO₂ injection nozzle 106. The nozzle 500 includes a main body 502, a fluid conduit 504 that is connected to a top end 506 of the main body 502, a perforated plate 510 positioned within a lumen 524 of the main body 502, a spring 534 (e.g., a tension spring) extending from the perforated plate 510, and an outlet plate 508 connected to a lower end of the spring 534. An axial position of the perforated plate 510 is fixed with respect to the main body 502. In some embodiments, instead of the perforated plate 510, the nozzle 500 alternatively includes a cross bar that is fixed within and extends across the lumen 524. In some embodiments, the main body 502 has an outer diameter in a range of about 2 cm to about 10 cm. Any of the components of the nozzle 500 may be made of one or more of composite materials (e.g., polymers and fibers), stainless steel, carbon steel, copper, and plastic. FIG. 6B illustrates an example embodiment of the perforated plate 510.

In operation, CO₂ gas 107 flows from a CO₂ source, through the conduit 504, through the lumen 524, and impacts a top surface of the outlet plate 508. Once enough CO₂ gas pressure accumulates against the outlet plate 508, the gas pressure pushes the outlet plate 508 downward and away from the main body 502, thereby allowing the CO₂ gas to flow through oppositely disposed fluid outlets 528 at a bottom end 512 of the main body 502. In some examples, the threshold gas pressure required to move the outlet plate 508 away from the main body is in a range of about 2 megapascals (MPa) to about 10 MPa. With the outlet plate 508 spaced apart from the main body 502, the CO₂ gas flows into the surrounding cementitious materials 101 while the cementitious materials 101 are in a liquid phase and experiencing vibration.

The plate 508 separates from the main body 502 by a distance that is small enough to prevent ingress of solid particles within the cementitious materials 101 from flowing into the fluid outlet 528 and plugging (e.g., blocking) the lumen 524. The distance is limited by the position of the cross bar 510 and an extent to which the spring 534 can extend from the cross bar 510. In some embodiments the distance is in a range of about 5 mm to about 10 mm. Once the flow of CO₂ gas into the fluid conduit 502 (e.g., from the CO₂ source) has decreased such that the pressure within the lumen 524 falls below the threshold gas pressure, the plate 508 moves back towards and against the main body 502, thereby closing the fluid outlet 528. In some embodiments, the fluid outlet 528 has a diameter in a range of about 1 cm to about 8 cm.

In some embodiments, an injection nozzle that is substantially similar in construction and function to any of the above-discussed nozzles 106, 206, 306, 406, 506 may alternatively be assembled with, built into, or otherwise integrated with a vibrator (e.g., the vibrator 104) such that a single device may be introduced into the cementitious materials 101 instead of a separate vibrator and nozzle being introduced into the cementitious materials 101.

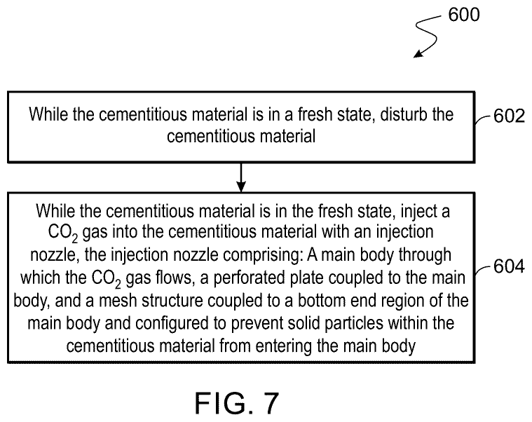

FIG. 7 is a flow chart illustrating an example method 600 of preparing a cementitious material (e.g., one or more cementitious materials 101). In some embodiments, the method 600 includes a step 602 for, while the cementitious material is in a fresh state, disturbing the cementitious material. In some embodiments, the method 600 includes a step 604 for, while the cementitious material is in the liquid phase, injecting a CO₂ gas (e.g., the CO₂ gas 107) into the cementitious material with an injection nozzle (e.g., the nozzle 106, 206, 306, 406, 506), the injection nozzle including a main body (e.g., the main body 202, 302, 402, 502) through which the CO₂ gas flows, a perforated plate (e.g., the perforated plate 208, 308, 408) coupled to the main body, and a mesh structure (e.g., the mesh structure 210, 230, 310; textile layer 410) coupled to a bottom end region of the main body and configured to prevent solid particles within the cementitious material from entering the main body.

While the nozzles 106, 206, 306, 406, 506 have been described and illustrated with respect to certain dimensions, sizes, shapes, arrangements, materials, and methods 600, in some embodiments, a nozzle that is otherwise similar in construction and/or function to any of nozzles 106, 206, 306, 406, 506 may include one or more different dimensions, sizes, shapes, arrangements, configurations, or materials, or be operated according to different methods.

### EXAMPLES

In an example aspect, a material preparation system includes a receptacle configured to contain a cementitious material, a vibrator configured to be disposed within the cementitious material while the cementitious material is disposed within the receptacle and in a fresh state, and an injection nozzle. The injection nozzle includes a main body, a perforated plate coupled to the main body, and a mesh structure coupled to a bottom end region of the main body and configured to prevent solid particles within the cementitious material from entering the main body.

Embodiments may provide one or more of the following features.

In an example aspect combinable with any other example aspect, the injection nozzle further includes a fluid conduit through which the main body receives a fluid.

In an example aspect combinable with any other example aspect, the fluid is a CO2 gas.

In an example aspect combinable with any other example aspect, the perforated plate is spaced apart from the bottom end region of the main body.

In an example aspect combinable with any other example aspect, the mesh structure has a frustoconical shape.

In an example aspect combinable with any other example aspect, the mesh structure is a first mesh structure, and the injection nozzle further includes a second mesh structure that is coupled to the bottom end region of the main body.

In an example aspect combinable with any other example aspect, the second mesh structure has a triangular shape.

In an example aspect combinable with any other example aspect, the main body forms a conically-shaped fluid outflow path.

In an example aspect combinable with any other example aspect, the perforated plate is positioned at the bottom end region of the main body.

In an example aspect combinable with any other example aspect, the mesh structure includes a textile layer.

In an example aspect combinable with any other example aspect, the injection nozzle and the vibrator are separate devices.

In an example aspect combinable with any other example aspect, the injection nozzle is integral with the vibrator.

In another example aspect, a method of preparing a cementitious material includes, while the cementitious material is in a fresh state: disturbing the cementitious material and injecting a CO2 gas into the cementitious material with an injection nozzle. The injection nozzle includes a main body through which the CO2 gas flows, a perforated plate coupled to the main body, and a mesh structure coupled to a bottom end region of the main body and configured to prevent solid particles within the cementitious material from entering the main body.

Embodiments may provide one or more of the following features.

In an example aspect combinable with any other example aspect, disturbing the cementitious material includes vibrating the cementitious material with a vibrator disposed within the cementitious material.

In an example aspect combinable with any other example aspect, the method further includes vibrating the cementitious material while the cementitious material is consolidated.

In an example aspect combinable with any other example aspect, the method further includes vibrating the cementitious material before a consolidation process on the cementitious material has begun.

In an example aspect combinable with any other example aspect, the cementitious material comprises one or more of sand, coarse aggregates, water, lime, cement, foam agents, and an admixture.

In an example aspect combinable with any other example aspect, the perforated plate is spaced apart from the bottom end region of the main body.

In an example aspect combinable with any other example aspect, the mesh structure has a frustoconical shape.

In an example aspect combinable with any other example aspect, the main body forms a conically-shaped fluid outflow path.

In another example aspect, a material preparation system includes a receptacle configured to contain a cementitious material, a vibrator configured to be disposed within the cementitious material while the cementitious material is disposed within the receptacle and in a liquid phase, and an injection nozzle. The injection nozzle includes a main body, a cross bar attached to the main body, a spring extending from the cross bar, and a plate attached to a bottom end of the spring and positioned to cover an opening in the main body, wherein the spring is configured to extend to allow the plate to move away from the opening in the main body in response to a threshold gas pressure being exerted on the plate.

The above-discussed examples and other examples are within the scope of the following claims.

What is claimed is:

1. A material preparation system comprising:
a receptacle configured to contain a cementitious material;
a vibrator configured to be disposed within the cementitious material while the cementitious material is disposed within the receptacle and in a fresh state; and
an injection nozzle comprising:
a main body,
a perforated plate coupled to the main body, and
a mesh structure coupled to a bottom end region of the main body and configured to prevent solid particles within the cementitious material from entering the main body.

2. The material preparation system of claim 1, wherein the injection nozzle further comprises a fluid conduit through which the main body receives a fluid.

3. The material preparation system of claim 2, wherein the fluid comprises a CO₂ gas.

4. The material preparation system of claim 1, wherein the perforated plate is spaced apart from the bottom end region of the main body.

5. The material preparation system of claim 1, wherein the mesh structure has a frustoconical shape.

6. The material preparation system of claim 5, wherein the mesh structure is a first mesh structure, and wherein the injection nozzle further comprises a second mesh structure that is coupled to the bottom end region of the main body.

7. The material preparation system of claim 6, wherein the second mesh structure has a triangular shape.

8. The material preparation system of claim 5, wherein the main body forms a conically-shaped fluid outflow path.

9. The material preparation system of claim 1, wherein the perforated plate is positioned at the bottom end region of the main body.

10. The material preparation system of claim 9, wherein the mesh structure comprises a textile layer.

11. The material preparation system of claim 1, wherein the injection nozzle and the vibrator are separate devices.

12. The material preparation system of claim 1, wherein the injection nozzle is integral with the vibrator.

13. A method of preparing a cementitious material, the method comprising:
while the cementitious material is in a fresh state:
disturbing the cementitious material; and
injecting a CO₂ gas into the cementitious material with an injection nozzle, the injection nozzle comprising:
an injection nozzle comprising:
a main body through which the CO₂ gas flows,
a perforated plate coupled to the main body, and
a mesh structure coupled to a bottom end region of the main body and configured to prevent solid particles within the cementitious material from entering the main body.

14. The method of claim 13, wherein disturbing the cementitious material comprises vibrating the cementitious material with a vibrator disposed within the cementitious material.

15. The method of claim 14, wherein the method further comprises vibrating the cementitious material while the cementitious material is consolidated.

16. The method of claim 14, wherein the method further comprises vibrating the cementitious material before a consolidation process on the cementitious material has begun.

17. The method of claim 13, wherein the cementitious material comprises one or more of sand, coarse aggregates, water, lime, cement, foam agents, and an admixture.

18. The method of claim 13, wherein the perforated plate is spaced apart from the bottom end region of the main body.

19. The method of claim 13, wherein the mesh structure has a frustoconical shape.

20. The method of claim 13, wherein the main body forms a conically-shaped fluid outflow path.
